(19) United States
(12) Patent Application Publication
(10) Pub. No.: US 2019/0079284 A1
(43) Pub. Date: Mar. 14, 2019

(54) Variable DPI Across A Display And Control Thereof

(71) Applicant: MediaTek Inc., Hsinchu City (TW)

(72) Inventor: Stephane Le Provost, San Jose, CA (US)

(21) Appl. No.: 15/699,834

(22) Filed: Sep. 8, 2017

(51) Int. Cl. G02B 27/00; G02B 27/01; H04N 13/04

(52) U.S. Cl. CPC G02B 27/0093; G02B 27/017; H04N 13/044; G02B 27/0172; G02B 2027/0147; G02B 2027/0187; G02B 2027/0134

(57) ABSTRACT

Techniques and examples pertaining to variable pixel density across a display and control thereof are described. A display controller circuit can receive data from a data source, and control a display device to display the data on a single display panel of the display device. The display panel has a variable pixel density across the display panel.

### TECHNICAL FIELD

The present disclosure is generally related to display devices and, more particularly, to variable DPI across a display and control thereof.

### BACKGROUND

Unless otherwise indicated herein, approaches described in this section are not prior art to the claims listed below and are not admitted to be prior art by inclusion in this section.

Existing displays for various applications, such as phones, tablets, laptops, monitors and televisions, typically have a single pixel density across the entire display area. Pixel density is sometimes referred as dots per inch (DPI) or pixels per inch (PPI). In applications in which the display is away from the eyes of the user it makes sense to have a single DPI across the display. This is because, in such applications, the entire display can be looked at with the same visual acuity due to freedom of movement of the eyes and head of the user. However, in applications in which the display is close to or even attached to the head of the user (e.g., head-mounted displays, or HMD, in the context of virtual reality applications), there could be some optimization of the display to better match and not exceed the capabilities of human eyes. Moreover, in cases where the eyes of the user cannot resolve certain details, there is no need to actually display such details. One example is the case of peripheral vision where the visual acuity of the human eyes is reduced.

With current display technologies, users can be sensitive to display resolution and associated quality to a certain extent such as, for example, 2560×1440 resolution for the display on smartphones and 4K resolution for the display on televisions. In some HMDs, lenses are added between the display and the eyes of the user, and the lenses are used to act like a magnifying glass to provide a wider field of view (FOV).

Nevertheless, increasing the display resolution to please the eye is not without associated cost and technical challenges. For instance, it is challenging to mass produce high-resolution displays with good yield and at acceptable cost. Moreover, there would be a high bandwidth requirement for the link interface between the display and the source of data for display (e.g., mobile system-on-chip (SoC), central processing unit (CPU) with integrated graphics processing unit (GPU), and discrete GPU). Additionally, high GPU performance would be required in order to render high resolution and higher frame rate which could be required in virtual reality (VR) applications. Furthermore, higher display resolution would require higher memory bandwidth.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose a solution that supports higher visual quality for HMD applications such as VR while the source of data for display may have certain limitations such as, for example, cost, performance, thermal constraints and technology availability. Compared to existing solutions, the proposed solution provides a number of benefits and advantages. With the proposed solution, the display cost is reduced, the GPU performance requirement is reduced, and the memory bandwidth requirement is reduced. Furthermore, the display link bandwidth is also reduced with the proposed solution, and latency is reduced to allow easier wireless transfer to standalone HMD.

In one aspect, an apparatus may include a display controller circuit. The display controller circuit may be capable of receiving data from a data source. The display controller circuit may be also capable of controlling a display device having a single display panel with a variable pixel density across the display panel to display the data on the display panel.

In another aspect, a method may involve receiving data from a data source. The method may also involve controlling a display device having a single display panel with a variable pixel density across the display panel to display the data on the display panel.

In another aspect, an apparatus may include a central processing unit (CPU) and a data source. The CPU may be capable of receiving inputs and generating commands with respect to the inputs. The data source may be capable of receiving the commands from the CPU and generating data based at least in part on the commands, the data displayable on a single display panel with a variable pixel density across the display panel.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example display panel in accordance with an implementation of the present disclosure.

FIG. 2 is a diagram of an example scenario in which various implementations in accordance with the present disclosure may be realized.

FIG. 3 is a block diagram of an example apparatus in accordance with an implementation of the present disclosure.

FIG. 4 is a diagram of an example apparatus in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

The proposed solution of the present disclosure involves a single display with a variable pixel density, or variable DPIs, across the display. That is, a single display in accordance with the present disclosure can have multiple regional pixel densities or pixel densities. That is, there are at least two regions in the single display with different regional pixel densities, and the number of regions in the single display with different regional pixel densities may vary depending on the actual implementation. Moreover, there is no specific constraint on how the regions are defined horizontally and/or vertically in terms of size. Furthermore, there is no specific constraint on how the regions are defined in terms of shape. For example, a given region may be rectangular, round, oval, elliptical or in any other shape.

Accordingly, the single display with a variable pixel density provides a higher (or highest) pixel density in an area of the display where the eye(s) of the user can have maximum visual acuity to resolve the minimum detail. Additionally, the single display with a variable pixel density provides a lower (or lowest) pixel density in an area of the display where the eye(s) of the user cannot look at more details due to a limited amount of eyeball rotation of typical human eyes.

Typically, to get a clear view of the world, the human brain needs to turn the eyes so that the image of an object of interest can fall on the fovea. If the eye movement is not enough then the head tends to move as well to achieve wider rotation. Thus, any failure to make eye movement correctly can lead to serious visual disabilities. When the object is located in the far peripheral region (e.g., beyond +/−60°) binocular vision tends to be difficult if not impossible, and one but not both eyes can look at the object.

Field of view (FOV) is the area within which, for a given fixation distance, form, brightness or color may be perceived without moving the eye(s) or the head. Field of fixation is the area within which central fixation is possible by moving the eye(s) but not the head. Beyond the field of fixation, it does not matter if there are different regions because the eyes cannot see the border between two regions of different pixel densities.

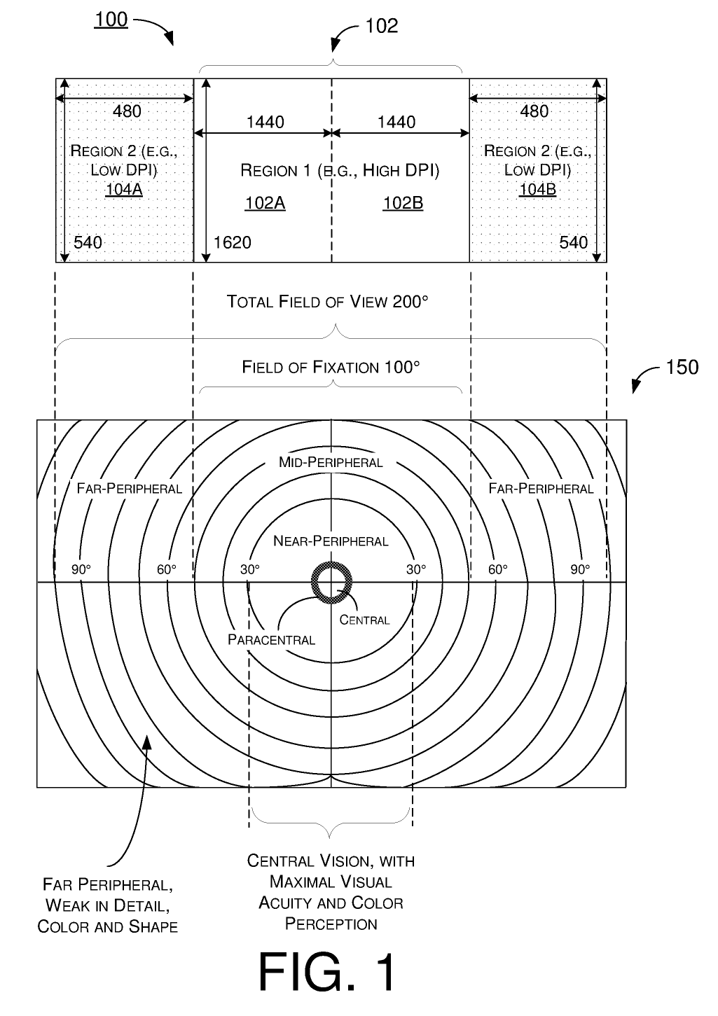

FIG. 1 illustrates an example display panel 100 in accordance with an implementation of the present disclosure. Referring to FIG. 1, display panel 100 may include multiple regions with different regional pixel densities (e.g., different regional DPIs and/or PPIs). In the example shown in FIG. 1, display panel 100 has a central region 102 (labeled as “Region 1” in FIG. 1) and two peripheral regions 104A and 104B (each labeled as “Region 2” in FIG. 1) on both sides of central region 102. Central region 102 may be seen as having two halves, namely a left half 102A and a right half 102B. According to the present disclosure, central region 102 has a regional pixel density higher than a regional pixel density of each of peripheral regions 104A and 104B. That is, in some implementations, central region 102 has a higher DPI, PPI and/or pixel density than that of peripheral regions 104A and 104B. In some implementations, central region 102 may have a 16:9 aspect ratio, and each of the halves 102A and 102B of central region 102 as well as each of the two peripheral regions 104A and 104B may have a 8:9 aspect ratio despite having different regional pixel densities. In the example shown in FIG. 1, each of the halves 102A and 102B of central region 102 has a regional pixel density or density of 1440×1620 pixels, and each of the two peripheral regions 104A and 104B has a regional pixel density or density of 480×540 pixels. In this example, the partial regions 102A, 102B, 104A and 104B have the same aspect ratio.

The location, shape and/or size (e.g., width and height) of each of central region 102 and peripheral regions 104A and 104B of display panel 100 may correspond to a field of vision 150 of eyes of a user. The field of vision 150 includes a field of fixation and a field of view. As shown in FIG. 1, in various implementations including implementations in virtual reality (VR) head-mounted display (HMD) applications, the location, shape and/or size of central region 102 may correspond to the field of fixation of eyes of a user, which is about 100° total (or 50° on either side of a centerline between the eyes of the user). The field of fixation corresponds to a field of central vision of the user, which typically has a maximal visual acuity and color perception. Moreover, peripheral regions 104A and 104B may correspond to both sides of the field of view excluding the field of fixation. The field of view is about 200° (or 100° on either side of the centerline between the eyes of the user). The two sides of the field of view outside the field of fixation correspond to fields of far peripheral vision of the user, which typically have weak visual acuity pertaining to detail, color and shape. Accordingly, in various display panels in accordance with the present disclosure, such as display panel 100, one or more regions of the display panel corresponding to the field of fixation (or field of central vision) may have a higher pixel density, while one or more other regions of the display panel may have a lower pixel density.

It is noteworthy that, although the shape of each of the halves 102A and 102B of central region 102 as well as each of the two peripheral regions 104A and 104B is rectangular in the example shown in FIG. 1, in various implementations the shape of each of the halves 102A and 102B of central region 102 as well as each of the two peripheral regions 104A and 104B may be different. For instance, the shape of each of the halves 102A and 102B of central region 102 as well as each of the two peripheral regions 104A and 104B may be round, oval, elliptical, ring-shaped, square, triangular or otherwise polygonal.

It is also noteworthy that, although there are three regions in the example shown in FIG. 1 (that is, central region 102 and peripheral regions 104A and 104B), in various implementations the number of regions in display panel 100 may be different than three. For instance, there may be two, four or more regions in display panel 100 with different regional pixel densities.

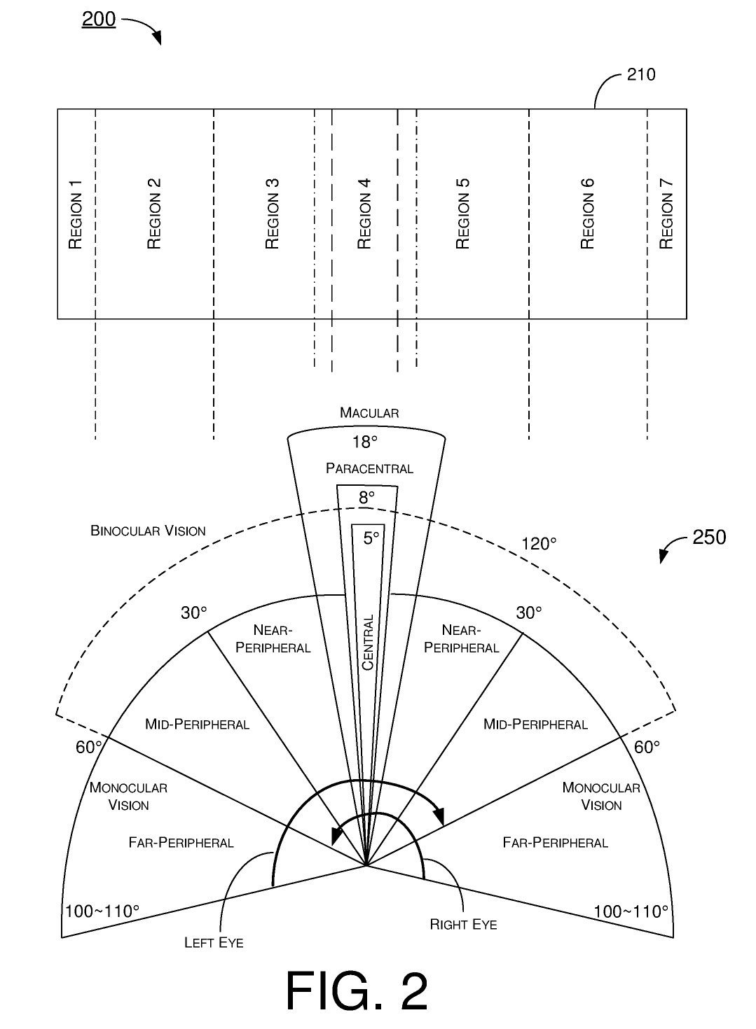

FIG. 2 illustrates an example scenario 200 in which various implementations in accordance with the present disclosure may be realized. In scenario 200, a display panel 210 in accordance with the present disclosure may have multiple (i.e., two or more) regions with different regional pixel densities. The location, shape and/or size of each of the multiple regions may correspond to a respective portion of a field of vision 250. For illustrative purpose and without limitation, in the example shown in FIG. 2, display panel 210 has region 1, region 2, region 3, region 4, region 5, region 6 and region 7 each of which having a respective regional pixel density which may or may not be different from one or more other regions of display panel 210. Each of region 1, region 2, region 3, region 4, region 5, region 6 and region 7 corresponds to a respective portion of the field of vision 250. As shown in FIG. 2, region 4 corresponds to the portions of central and paracentral visions of the field of vision 250. Each of region 3 and region 5 corresponds to a portion of near peripheral vision of the field of vision 250. Each of region 2 and region 6 corresponds to a portion of mid peripheral vision of the field of vision 250. Each of region 1 and region 7 corresponds to a portion of far peripheral vision of the field of vision 250. Region 4 may be within the field of fixation. The size of region 4, and correspondingly the size of each of region 3 and region 5, may vary depending on whether the eyes of the user are moving or not moving. Conversely, region 4 may be relatively wider (and each of region 3 and region 5 relatively narrower such that regions 3, 4 and 5 may have approximately the same width), as the eyes can look at region 3, region 4 and region 5 with the same acuity.

In some implementations, region 4 may have a highest pixel density; region 3 and region 5 may have a high pixel density; region 2 and region 6 may have a medium pixel density; and region 1 and region 7 may have a low pixel density. Alternatively, region 3, region 4 and region 5 may have a high (or highest) pixel density; and region 1, region 2, region 6 and region 7 may have a medium or low pixel density. The above example implementations are provided for illustrative purposes and, perceivably, there may be different combinations of different regional pixel densities to result in a variable pixel density across display panel 210. In the interest of brevity an exhaustive list of possible combinations is not provided herewith.

### Illustrative Implementations

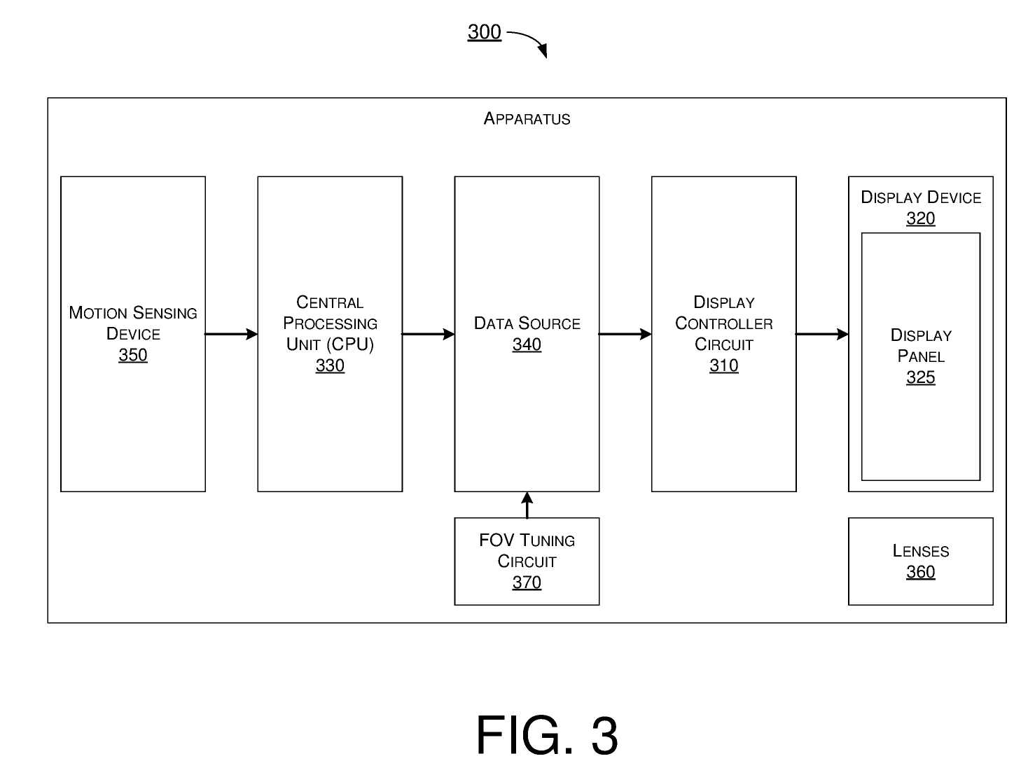

FIG. 3 illustrates an example apparatus 300 in accordance with an implementation of the present disclosure. Apparatus 300 may perform various functions to implement schemes, techniques, solutions, processes and methods described herein pertaining to variable pixel density across a display and control thereof, such as those described above with respect to display panel 100 and scenario 200 as well as apparatus 400 and process 500 described below. Apparatus 300 may be a part of an electronic apparatus, which may be a computing apparatus, a portable or mobile apparatus, or a wearable apparatus. For instance, apparatus 300 may be implemented in or as a head-mounted display, a smartphone, a smartwatch, a smart bracelet, a smart necklace, a personal digital assistant, or a computing device such as a tablet computer, a laptop computer, a notebook computer, a desktop computer, or a server. Apparatus 300 may include one, some or all of those components shown in FIG. 3 in various implementations. It is noteworthy that apparatus 300 may optionally include one or more components not shown in FIG. 3 (e.g., power supply, user interface and/or input/output device), and such component(s) is/are not the focus of the present disclosure and, thus, is/are neither shown in FIG. 3 nor described herein for simplicity and brevity.

In some implementations, apparatus 300 may include a display controller circuit 310 (hereinafter interchangeably referred as “display controller” and/or “display driver”). In some other implementations, in addition to display controller circuit 310, apparatus 300 may also include a display device 320 having a single display panel 325 with a variable pixel density (e.g., variable DPI or PPI) across display panel 325. In some implementations, display panel 325 may have a plurality of regions with different regional pixel densities. Display panel 325 may be an example implementation of display panel 100 and/or display panel 210. Accordingly, descriptions above with respect to display panel 100 and display panel 210 are applicable to display panel 325 and are not repeated in the interest of brevity.

Display controller circuit 310 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, display controller circuit 310 is a special-purpose hardware specifically designed, built and configured to perform, execute or otherwise carry out specialized algorithms, software instructions, computations and/or logics to render or otherwise effect displaying data on a display (e.g., display panel 325) with a variable pixel density and control thereof in accordance with the present disclosure.

In some implementations, display controller circuit 310 may receive data from a data source 340 (e.g., a GPU). Display controller circuit 310 may also control a display device (e.g., display device 320) having a single display panel (e.g., display panel 325) with a variable pixel density across the display panel to display the data on the display panel. Such data may be, for example and without limitation, video(s), graphics, still image(s), textual information, or any combination thereof. In some implementations, in controlling the display device to display the data, display controller circuit 310 may control the display device to display a video data on the display panel which has a plurality of regions with different regional pixel densities. Alternatively or additionally, in controlling the display device to display the data, display controller circuit 310 may control the display device to display a video data on the display panel which has a central region and two peripheral regions on two sides of the central region. For instance, a regional pixel density of the central region may be higher than a regional pixel density of each of the two peripheral regions.

In some implementations, in receiving the data from the data source 340, display controller circuit 310 may receive data displayable on another display panel (e.g., a second display panel) having a same pixel density across the second display panel. In such cases, display controller circuit 310 may process the data displayable on the second display panel to provide a processed data displayable on the display panel with the variable pixel density. That is, multiple display panels/monitors, whether with identical pixel density or different pixel densities, may be driven by display controller circuit 310. For instance, display controller circuit 310 may receive high-pixel density data from the data source 340, and may process the data to simulate lower pixel density (e.g., lower DPI) to be displayed on region(s) of display panel 325 where the regional pixel density is relatively lower than that of one or more other regions. In some implementations, in processing the data displayable on the another display panel to provide the processed data displayable on the display panel with the variable pixel density, display controller circuit 310 may divide the received data into a plurality of portions and mapping each of the plurality of portions of the received data to a respective one of a plurality of regions of the display panel, with the plurality of regions having different regional pixel densities.

In some implementations, in receiving the data from the data source 340, display controller circuit 310 may receive data that is displayable on the display panel of the display device having the variable pixel density without processing by display controller circuit 310.

In some implementations, in lieu of display controller circuit 310 and/or display device 320, apparatus 300 may include a central processing unit (CPU) 330 and a data source 340. CPU 330 may be capable of receiving inputs and generating commands with respect to the inputs. Data source 340 may be capable of receiving the commands from CPU 330 and generating data based at least in part on the commands. The data generated by data source 340 may be displayable on a single display panel with a variable pixel density across the display panel (e.g., display panel 325). In some implementations, data source 340 may be a GPU, a custom hardware engine, or a digital signal processor (DSP). In some implementations, CPU 330 and data source 340, as a GPU, may be implemented based on software and driver(s), and such software may evolve depending on hardware availability and technology. For instance, the software implementation may include industry standards such as OpenGL®, OpenGL Embedded Systems (ES)™ and/or Vulkan™.

In some implementations, data source 340 may generate a video data displayable on the display panel which has a plurality of regions with different regional pixel densities.

In some implementations, data source 340 may generate a video data displayable on the display panel which has a central region and two peripheral regions on two sides of the central region. In some implementations, a regional pixel density of the central region may be higher than a regional pixel density of each of the two peripheral regions.

In some implementations, in generating the data, data source 340 may perform a number of operations. For instance, data source 340 may divide the data into a plurality of portions. Moreover, data source 340 may map each of the plurality of portions of the data to a respective one of a plurality of regions of the display panel. The plurality of regions may have different regional pixel densities.

Alternatively or additionally, data source 340 may perform a number of other operations. For instance, data source 340 may determine whether to generate first data that is displayable on the display panel with the variable pixel density across the display panel or to generate second data that is displayable on another display panel (e.g., a second display panel) with a same pixel density across the second display panel. Additionally, data source 340 may generate the first data responsive to a determination that an output of the data source 340 is to be displayed by the display panel with the variable pixel density. Moreover, data source 340 may generate the second data responsive to a determination that the output of the data source 340 is to be displayed by the second display panel with the same pixel density. Thus, data source 340 (e.g., a single GPU) may drive multiple display panels/monitors, which may have identical pixel density or different pixel densities.

In some implementations, CPU 330 may receive inputs from a motion sensing device to generate commands to control data source 340 to generate left-eye data for viewing by a left eye of a user and right-eye data for viewing by a right eye of the user. For instance, apparatus 300 may additionally include a motion sensing device 350 having one or more motion sensors capable of sensing, detecting or otherwise recording internal measurements of apparatus 300 to generate data as inputs to CPU 330.

In some implementations, in addition to CPU 330 and data source 340, apparatus 300 may also include display controller circuit 310 (and optionally display device 320). As described above, display controller circuit 310 may be capable of receiving the data from data source 340 to control a display device (e.g., display device 320) having the single display panel with the variable pixel density across the display panel (e.g., display panel 325) to display the data on the display panel in accordance with the present disclosure.

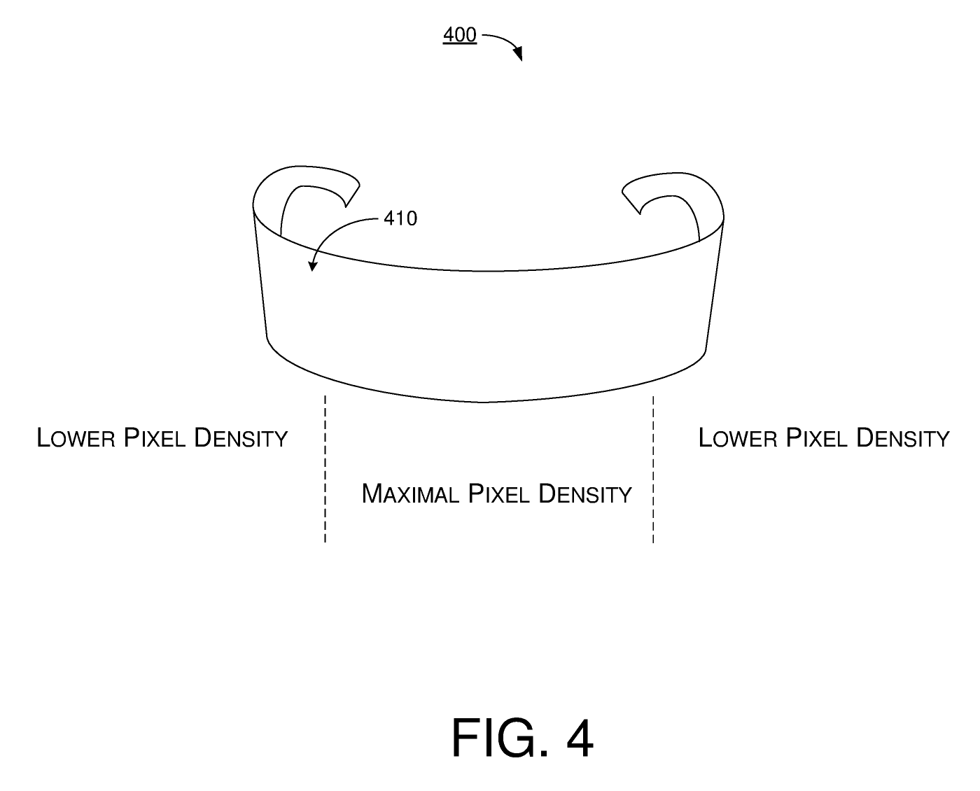

FIG. 4 illustrates an example apparatus 400 in accordance with an implementation of the present disclosure. Apparatus 400 may perform various functions to implement schemes, techniques, solutions, processes and methods described herein pertaining to variable pixel density across a display and control thereof, such as those described above with respect to display panel 100, scenario 200 and apparatus 300 as well as process 500 described below. Apparatus 400 may be a part of an electronic apparatus, which may be a wearable apparatus. For instance, apparatus 400 may be a head-mounted display (HMD). Apparatus 400 may be an example implementation of apparatus 300 and, thus, may include one, some or all of those components of apparatus 300 shown in FIG. 3.

Apparatus 400 has a display panel 410 that has a variable pixel density (e.g., variable DPI/PPI) across display panel 410. In the example shown in FIG. 4, display panel 410 has a region (e.g., central region) with a maximal pixel density or pixel density and one or more other regions (e.g., peripheral regions) each with a lower pixel density or pixel density. Display panel 410 may be controlled by electronics such as those shown in FIG. 3 (e.g., display controller circuit 310, CPU 330 and/or data source 340) to display data (e.g., video(s), graphics, still image(s), textual information, or any combination thereof).

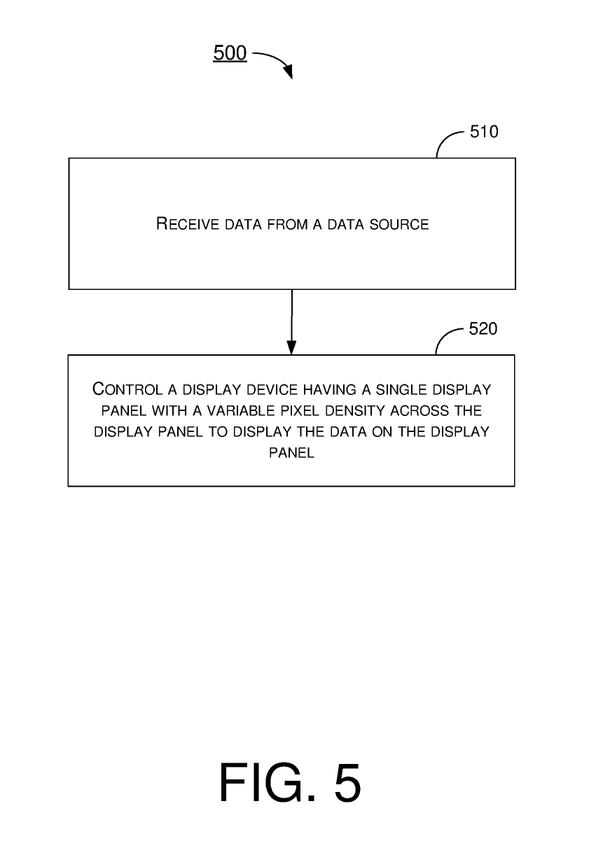

FIG. 5 illustrates an example process 500 in accordance with an implementation of the present disclosure. Process 500 may be an example implementation of schemes, techniques, processes and methods described herein pertaining to variable pixel density across a display and control thereof, such as those described above with respect to display panel 100, scenario 200, apparatus 300 and apparatus 400, whether partially or completely. Process 500 may represent an aspect of implementation of features of apparatus 300 and apparatus 400. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively in a different order. Process 500 may be implemented by apparatus 300 and/or apparatus 400. Solely for illustrative purposes and without limitation, process 500 is described below in the context of apparatus 300. Process 500 may begin at block 510.

At 510, process 500 may involve display controller circuit 310 of apparatus 300 receiving data from a data source (e.g., data source 340). Process 510 may proceed from 510 to 520.

At 520, process 500 may involve display controller circuit 310 of apparatus 300 controlling a display device (e.g., display device 320) having a single display panel (e.g., display panel 325) with a variable pixel density across the display panel to display the data on the display panel.

In some implementations, in controlling the display device to display the data, process 500 may involve display controller circuit 310 controlling the display device to display a video data on the display panel which has a plurality of regions with different regional pixel densities.

In some implementations, in controlling the display device to display the data, process 500 may involve display controller circuit 310 controlling the display device to display a video data on the display panel which has a central region and two peripheral regions on two sides of the central region. In such cases, a regional pixel density of the central region may be higher than a regional pixel density of each of the two peripheral regions.

In some implementations, in receiving the data from the data source, process 500 may involve display controller circuit 310 performing a number of operations. For instance, process 500 may involve display controller circuit 310 receiving data displayable on another display panel having a same pixel density across the another display panel. Additionally, process 500 may involve display controller circuit 310 processing the data displayable on the another display panel to provide a processed data displayable on the display panel with the variable pixel density across the display panel. For instance, display controller circuit 310 may receive high-pixel density data from the data source (e.g., data source 340), and process 500 may involve display controller circuit 310 processing the data to simulate lower pixel density (e.g., lower DPI) to be displayed on region(s) of display panel 325 where the regional pixel density is relatively lower than that of one or more other regions.

In some implementations, in processing the data displayable on the another display panel to provide the processed data displayable on the display panel with the variable pixel density, process 500 may involve display controller circuit 310 performing a number of operations. For instance, process 500 may involve display controller circuit 310 dividing the received data into a plurality of portions. Moreover, process 500 may involve display controller circuit 310 mapping each of the plurality of portions of the received data to a respective one of a plurality of regions of the display panel, with the plurality of regions having different regional pixel densities.

In some implementations, in receiving the data from the data source, process 500 may involve display controller circuit 310 receiving data that is displayable on the display panel of the display device having the variable pixel density without processing by a display controller circuit.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. An apparatus, comprising:
a display controller circuit capable of receiving data from a data source, the display controller circuit further capable of controlling a display device having a single display panel with a variable pixel density across the display panel to display the data on the display panel.

2. The apparatus of claim 1, wherein, in controlling the display device to display the data, the display controller circuit is capable of controlling the display device to display a video data on the display panel which has a plurality of regions with different regional pixel densities.

3. The apparatus of claim 1, wherein, in controlling the display device to display the data, the display controller circuit is capable of controlling the display device to display a video data on the display panel which has a central region and two peripheral regions on two sides of the central region, and wherein a regional pixel density of the central region is higher than a regional pixel density of each of the two peripheral regions.

4. The apparatus of claim 1, wherein, in receiving the data from the data source, the display controller circuit is capable of receiving data displayable on another display panel having a same pixel density across the another display panel, and wherein the display controller circuit is capable of processing the data displayable on the another display panel to provide a processed data displayable on the display panel with the variable pixel density.

5. The apparatus of claim 4, wherein, in processing the data displayable on the another display panel to provide the processed data displayable on the display panel with the variable pixel density, the display controller circuit is capable of dividing the received data into a plurality of portions and mapping each of the plurality of portions of the received data to a respective one of a plurality of regions of the display panel, and wherein the plurality of regions have different regional pixel densities.

6. The apparatus of claim 1, wherein, in receiving the data from the data source, the display controller circuit is capable of receiving data that is displayable on the display panel of the display device having the variable pixel density without processing by the display controller circuit.

7. The apparatus of claim 1, further comprising:
the display device having the single display panel with the variable pixel density across the display panel.

8. A method, comprising:
receiving data from a data source; and
controlling a display device having a single display panel with a variable pixel density across the display panel to display the data on the display panel.

9. The method of claim 8, wherein the controlling of the display device to display the data comprises controlling the display device to display a video data on the display panel which has a plurality of regions with different regional pixel densities.

10. The method of claim 8, wherein the controlling of the display device to display the data comprises controlling the display device to display a video data on the display panel which has a central region and two peripheral regions on two sides of the central region, and wherein a regional pixel density of the central region is higher than a regional pixel density of each of the two peripheral regions.

11. The method of claim 8, wherein the receiving of the data from the data source comprises:
receiving data displayable on another display panel having a same pixel density across the another display panel; and
processing the data displayable on the another display panel to provide a processed data displayable on the display panel with the variable pixel density across the display panel.

12. The method of claim 11, wherein the processing of the data displayable on the another display panel to provide the processed data displayable on the display panel with the variable pixel density comprises:
dividing the received data into a plurality of portions; and
mapping each of the plurality of portions of the received data to a respective one of a plurality of regions of the display panel, and wherein the plurality of regions have different regional pixel densities.

13. The method of claim 8, wherein the receiving of the data from the data source comprises receiving data that is displayable on the display panel of the display device having the variable pixel density without processing by a display controller circuit.

14. An apparatus, comprising:
a central processing unit (CPU) capable of receiving inputs and generating commands with respect to the inputs; and
a data source capable of receiving the commands from the CPU and generating data based at least in part on the commands, the data displayable on a single display panel with a variable pixel density across the display panel.

15. The apparatus of claim 14, wherein the data source is capable of generating a video data displayable on the display panel which has a plurality of regions with different regional pixel densities.

16. The apparatus of claim 14, wherein the data source is capable of generating a video data displayable on the display panel which has a central region and two peripheral regions on two sides of the central region, and wherein a regional pixel density of the central region is higher than a regional pixel density of each of the two peripheral regions.

17. The apparatus of claim 14, wherein, in generating the data, the data source is capable of performing operations comprising:
dividing the data into a plurality of portions; and
mapping each of the plurality of portions of the data to a respective one of a plurality of regions of the display panel, and wherein the plurality of regions have different regional pixel densities.

18. The apparatus of claim 14, wherein the data source is capable of performing operations comprising:
determining whether to generate first data that is displayable on the display panel with the variable pixel density across the display panel or to generate second data that is displayable on another display panel with a same pixel density across the another display panel;
generating the first data responsive to a determination that an output of the data source is to be displayed by the display panel with the variable pixel density; and
generating the second data responsive to a determination that the output of the data source is to be displayed by the another display panel with the same pixel density.

19. The apparatus of claim 14, wherein the CPU is capable of receiving inputs from a motion sensing device to generate commands to control the data source to generate left-eye data for viewing by a left eye of a user and right-eye data for viewing by a right eye of the user.

20. The apparatus of claim 14, further comprising:
a display controller circuit capable of receiving the data from the data source, the display controller circuit further capable of controlling a display device having the single display panel with the variable pixel density across the display panel to display the data on the display panel.
